(19) United States
(12) Patent Application Publication
(10) Pub. No.: US 2018/0224404 A1
(43) Pub. Date: Aug. 9, 2018

(54) COORDINATED COMPOSITION GRADIENT AND TEMPERATURE GRADIENT LIQUID CHROMATOGRAPHY

(71) Applicant: Waters Technologies Corporation, Milford, MA (US)

(72) Inventors: Michael O. Fogwill, South Grafton, MA (US); Martin Gilar, Franklin, MA (US); Fabrice Gritti, Franklin, MA (US); Joseph D. Michienzi, Plainville, MA (US)

(21) Appl. No.: 15/891,463

(22) Filed: Feb. 8, 2018

Related U.S. Application Data
(60) Provisional application No. 62/456,716, filed on Feb. 9, 2017.

(51) Int. Cl. G01N 30/30

(52) U.S. Cl. CPC G01N 30/30; G01N 2030/3015; G01N 2030/027; G01N 2030/3038; G01N 2030/3053; G01N 2030/3046

(57) ABSTRACT

A method of performing a chromatographic separation includes generating a spatial temperature gradient along a length of a chromatographic column in a liquid chromatography system. A sample is injected into a flow of a mobile phase to the column and a flow of a mobile phase having a composition gradient is provided to the column after the sample is received at the column. The spatial temperature gradient is moved along the length of the column from the column inlet to the column outlet during the time that the composition gradient traverses the column. This coordination of the composition gradient with the movement of the spatial thermal gradient yields a significant increase in peak capacity per unit time compared with conventional separation techniques performed in a conventional isothermal column environment.

### RELATED APPLICATIONS

This application claims the benefit of U.S. Provisional Application No. 62/456,716, filed on Feb. 9, 2017, and titled “COORDINATED COMPOSITION GRADIENT AND TEMPERATURE GRADIENT LIQUID CHROMATOGRAPHY,” the entirety of which is incorporated by reference herein.

### FIELD OF THE INVENTION

The invention relates generally to chromatography systems. More particularly, the invention relates to a method and system utilizing a mobile phase composition gradient and a moving spatial thermal gradient in a coordinated manner to achieve increased chromatographic peak compression and peak capacity in gradient elution.

### BACKGROUND

Chromatography is a set of techniques for separating a mixture into its constituents. For instance, in a liquid chromatography (LC) application, a solvent delivery system takes in a liquid solvent, or mixture of solvents, and provides a mobile phase to an autosampler (also called an injection system or sample manager) where a sample to be analyzed is injected into the mobile phase. The mobile phase with the injected sample flows to a chromatographic column. As the mobile phase passes through the column, the various components in the sample are differentially retained and thus elute from the column at different times. A detector senses the separated components eluted from the column and generates an output signal or chromatogram from which the identity and quantity of the analytes can be determined.

A gradient mobile phase may be used for samples that are not easily separated using an isocratic mobile phase due to a wide range in retention. The composition of the mobile phase can be changed over time to increase its elution strength. The time to complete the separation is therefore reduced and the widths of peaks in the chromatogram are narrowed relative to an isocratic separation for the same sample. Regardless, in some gradient separations of very complex mixtures, the width of the peaks may still present a limitation on the ability to detect certain components in the sample and to distinguish between components having similar retention times.

### SUMMARY

In one aspect, the invention features a method of performing a chromatographic separation. The method includes generating a spatial temperature gradient along a length of a chromatographic column between an inlet of the chromatographic column and an outlet of the chromatographic column. A flow of a mobile phase having a composition gradient is provided to the chromatographic column and the spatial temperature gradient is moved along the length of the chromatographic column from the inlet to the outlet during the composition gradient.

In another aspect, the invention features a method of performing a chromatographic separation in which a spatial temperature gradient is generated along a length of a chromatographic column between an inlet of the chromatographic column and an outlet of the chromatographic column. The spatial temperature gradient has an inlet temperature and an outlet temperature. A sample is injected into a flow of an isocratic mobile phase to the chromatographic column. A flow of a mobile phase having a composition gradient is provided to the chromatographic column after the sample is received at the chromatographic column. The spatial temperature gradient is moved along the length of the chromatographic column from the inlet to the outlet during the composition gradient.

In another aspect, the invention features a chromatographic system that includes a solvent delivery system, a chromatographic column, a thermal system and a control module. The solvent delivery system is configured to provide a mobile phase having a composition gradient. The chromatographic column is in fluidic communication with the solvent delivery system to receive the mobile phase. The thermal system is in thermal communication with the chromatographic column and is configured to generate and dynamically control a spatial temperature gradient along a length of the chromatographic column. The control module is in communication with the solvent delivery system and the thermal system. The control module is configured to control the thermal system to move the spatial temperature gradient along the length of the chromatographic column from the inlet to the outlet during the composition gradient.

### BRIEF DESCRIPTION OF THE DRAWINGS

The above and further advantages of this invention may be better understood by referring to the following description in conjunction with the accompanying drawings, in which like reference numerals indicate like elements and features in the various figures. It is to be understood that terms such as above, below, upper, lower, left, leftmost, right, rightmost, top, bottom, front, and rear are relative terms used for purposes of simplifying the description of features as shown in the figures, and are not used to impose any limitation on the structure or use of embodiments described herein. For clarity, not every element may be labeled in every figure. The drawings are not necessarily to scale, emphasis instead being placed upon illustrating the principles of the invention.

FIG. 1A is a diagram of an embodiment of a thermal system for producing a thermal gradient near a fluidic channel (e.g., a chromatography column) in a microfluidic device using one or more thick film heaters.

FIG. 1B is a diagram of an embodiment of a thermal system for producing a thermal gradient near a fluidic channel in a microfluidic device.

FIG. 1C is a diagram of an embodiment of a thermal system for producing a thermal gradient near a fluidic channel in a microfluidic device.

FIG. 1D is a diagram of an embodiment of a thermal system for producing a thermal gradient near a fluidic channel in a microfluidic device.

FIG. 1E is a diagram of an embodiment of a thermal system for producing a thermal gradient near a fluidic channel in a microfluidic device.

FIG. 1F is a diagram of an embodiment of a multi-zone thermal system for producing a thermal gradient near a fluidic channel in a microfluidic device.

FIG. 1G is a diagram of an embodiment of a multi-zone thermal system for producing a thermal gradient near a fluidic channel in a microfluidic device.

FIG. 2A is a diagram of two heaters (a trapezoidal heater and a rectangular heater) connected in parallel.

FIG. 2B is an example of a temperature plot associated with the trapezoidal heater of FIG. 2A.

FIG. 2C is an example of a temperature plot associated with the rectangular heater of FIG. 2A.

FIG. 3 is a diagram of an embodiment a technique for shaping a thermal gradient using a thick film heater and a shaped cooling mechanism.

FIG. 4 is a diagram of an embodiment of a thermal system for producing a spatial thermal gradient near a fluidic channel (e.g., a separation column) in a microfluidic device using two thick-film heaters, specifically, a trapezoidal heater and a rectangular heater, in conjunction.

FIG. 5A is a diagram of an analytical scale chromatography column having a triangular-shaped resistive heating element on one side of the column.

FIG. 5B is a diagram of the analytical scale chromatography column of FIG. 7A having a rectangular-shaped heating element on an opposite side of the column.

FIG. 6 is a diagram of an analytical scale chromatography column surrounded by a heated column sleeve, wherein mobile phase passes through the column in one direction and cooling gas flows around the column within the heated sleeve in an opposite direction.

FIG. 7 is a diagram of an embodiment of an analytical scale chromatography column having a plurality of discrete, independently operable resistive heater elements wrapped circumferentially around a surface of the column.

FIG. 8 is a transparent side view of an embodiment of a multi-zone thermal system, including a column block coupled to a thermal block, used to produce a spatial thermal gradient around a column.

FIG. 9 is a diagram of an analytical scale column in thermal communication with a surface upon which a thermal gradient has already been formed.

FIG. 10 is a flowchart representation of an embodiment of a method of performing a chromatographic separation which uses a coordinated composition gradient and temperature gradient.

FIG. 11 is an example of a temperature plot showing a linear spatial temperature gradient along a length of a chromatographic column.

FIG. 12 is an example of a linear gradient composition.

FIGS. 13A to 13F show a time sequence of an example of how a linear spatial temperature gradient is made to move along an axis of a chromatographic column.

FIGS. 14A to 14F show a time sequence of an example of how a linear spatial temperature gradient moves along an axis of a chromatographic column.

FIG. 15 is a graphical representation of an example of the peak capacity of a liquid chromatography system per unit time as a function of composition gradient steepness and temperature steepness

FIG. 16 is a graphical representation of an example of the gain in resolution relative to a conventional, isothermal composition gradient as a function of temperature steepness and composition steepness for the liquid chromatography system associated with FIG. 15.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The ability to dynamically control the composition of a mobile phase according to a composition gradient can be used to improve the peak capacity of a chromatography system. Although the width of the chromatographic peaks may be reduced using a composition gradient, a further reduction in peak width is generally desired when analytes elute close in time.

In brief overview, chromatography methods and systems described herein use a simultaneous combination of a composition gradient (i.e., a solvent gradient) and a moving spatial thermal gradient to achieve a further reduction in chromatographic peak width. In this method of combined solvent-programmed and temperature-programmed gradient liquid chromatography (CST-GLC), the composition gradient and the spatial thermal gradient can propagate at independent velocities. In some embodiments, the composition gradient and the spatial thermal gradient propagate at the same velocity. In some embodiments, the initiation and termination of the movement of the spatial thermal gradient along the direction of the chromatographic column axis is synchronized with the initiation and termination of the composition gradient at the chromatographic column. This synchronization of the composition gradient with the movement of the spatial thermal gradient can lead to a significant improvement in peak fidelity.

Various types of liquid chromatography systems may be used to perform a separation. Such systems may include a microfluidic device having thick films used to form electronic elements, such as conductors, resistive heaters, heat spreaders, and sensors, on the microfluidic device. These elements can be used to produce, shape, and control a thermal gradient on the microfluidic device. U.S. Patent Publication No. 2016/0167048 A1, titled “Apparatus and Methods for Creating a Static and Traversing Thermal Gradient on a Microfluidic Device,” the entirety of which is incorporated herein by reference, describes different configurations of thick films on microfluidic devices to produce, shape, and control a thermal gradient. In some systems, one or more thick film heaters are formed of a ferromagnetic material and an electrical supply uses induction to cause current to flow through these heaters.

Direct application of shaped thick film heaters on the surface or embedded in the substrate of the microfluidic device adds design flexibility and control of the thermal gradient profile. An advantage achieved by the thick films is the ability to trim or shape a heater to linearize the thermal region. Shaping the resistive element (i.e., heater) can be an effective technique for thermal control. A trapezoid heater, for example, has a higher current density, and thus is warmer, at its narrow end than at its wide end.

In addition, cooling, thermal breaks in the substrate of the microfluidic device, or a combination thereof, can shape the thermal gradient and mitigate conduction beyond a desired thermal region. Thermal breaks can also prove effective in producing a thermal gradient because of the surface area and volume differences from one end of the microfluidic device to its other end. A larger volume and surface area increases the thermal load of the microfluidic device, in turn, lowering the temperature. Thick films are also capable of achieving the high temperatures and heating rates needed for performing liquid chromatography separations.

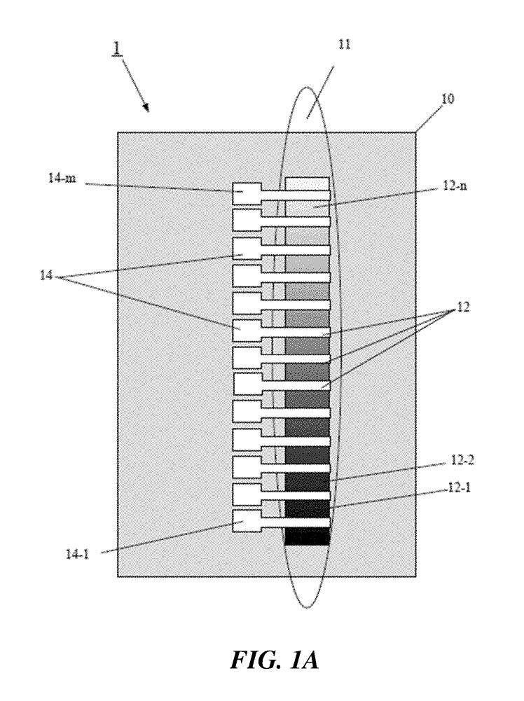

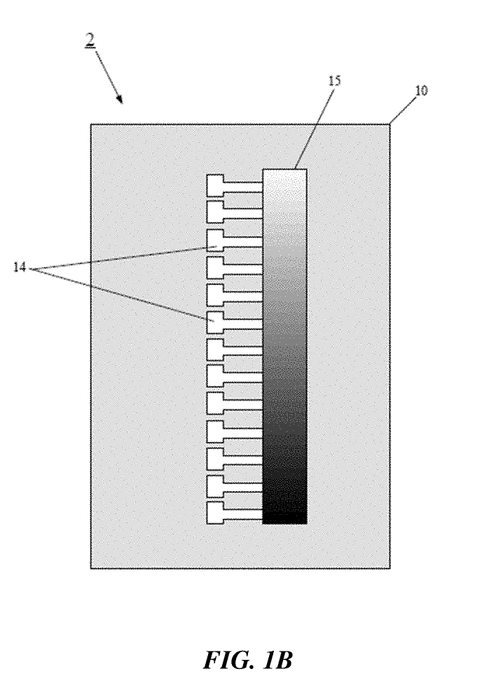

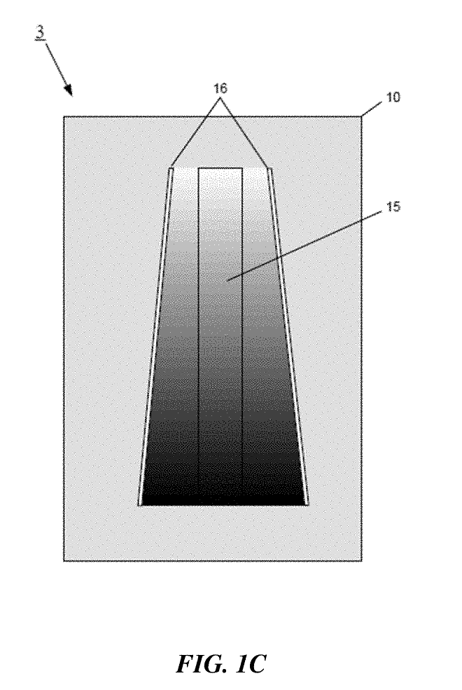

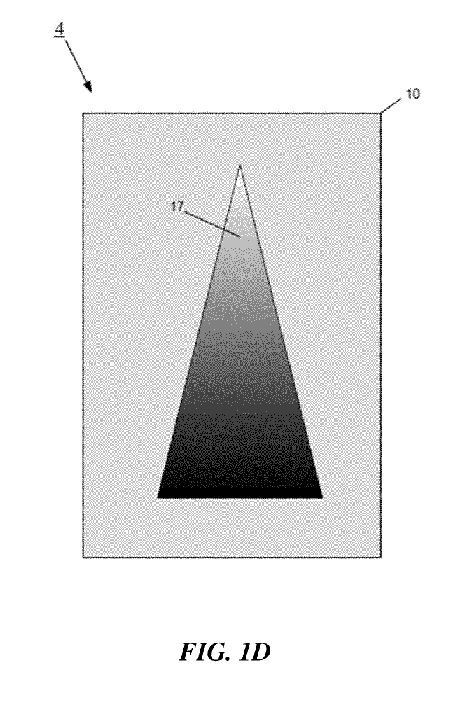

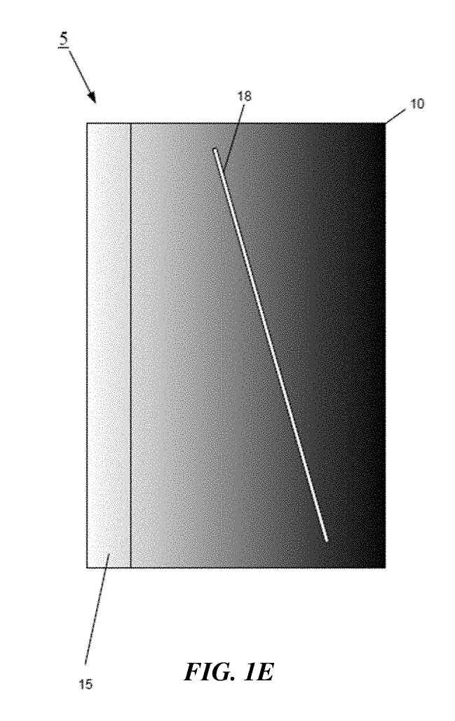

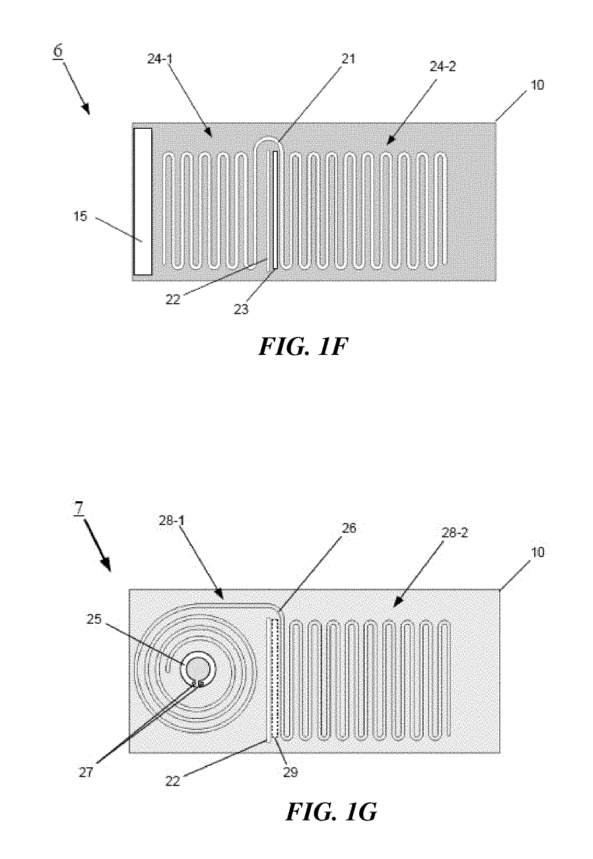

FIGS. 1A-1G show embodiments of thermal systems 1, 2, 3, 4, 5, 6, and 7 for producing a thermal gradient near a fluidic channel (e.g., a chromatography column) in a microfluidic device 10 using one or more thick film heaters. In brief overview, each thick film heater is formed on an interior or exterior layer of the microfluidic device, where that thick film heater is in thermal communication with the fluidic channel of the microfluidic device. Operation of the one or more thick film heaters produces a thermal gradient within the fluidic channel. FIGS. 1A-1E represent a thermal gradient as gradual transition from darker regions, representing cool temperatures, to lighter regions, representing warmer temperatures. In FIG. 1F the thermal gradient (not depicted) is an approximate linear decrease in temperature from a thick film heater 15 to a thermal break 22 and the region to the right of the thermal break is at a substantially cooler temperature. In FIG. 1G the thermal gradient (not depicted) is an approximately radial gradient with respect to a thick film heater 25 in a first thermal zone 28-1 and a substantially cooler temperature region to the right of a thermal break 22 in a second thermal zone 28-2. The thermal gradient can be static or be dynamically controlled to move along or traverse the fluidic channels. In addition, the thermal gradient may be controlled to change in shape.

Low-Temperature Co-fired Ceramic (LTCC) or High-Temperature Co-fired ceramic (HTCC) tapes can be used manufacture the microfluidic substrate on which the one or more thick film heaters are applied. Examples of LTCC tapes include the 951 Green Tape™ ceramic tape produced by DuPont Microcircuit Materials of Research Triangle Park, N.C., and LTCC ceramic tapes produced by ESL Electro Science of King of Prussia, Pa. LTCC technology enables low-temperature (about 850° C.) co-firing of the thick film heater and substrate layers of the multilayer microfluidic device. These microfluidic devices can be made, for example, of ceramic, silicon, silica, polymers, polyimide, stainless steel, or titanium. Examples of multilayer microfluidic devices are described in U.S. Pat. No. 8,931,356, titled “Chromatography Apparatus and Methods Using Multiple Microfluidic Substrates,” the entirety of which is incorporated by reference herein. Although not shown, embodiments of thermal systems can include a cooling element, such as a heat sink, fans, fluidic cooling, or a Peltier device, to quickly reduce the temperature of the microfluidic device whenever desired.

FIG. 1A shows an embodiment of thermal system 1 including a microfluidic device 10 with a segmented thick film heater 11 comprised of a plurality of spatially separated discrete thick film heaters 12 (or heater segments 12) disposed in thermal communication with a fluidic channel (not shown) within the microfluidic device 10. The thermal system 1 further includes a plurality of electrically conductive taps 14 by which a voltage can be individually supplied to, or a current individually driven through, the discrete heaters 12. The electrically conductive taps 14 can be made, for example, of a silver-palladium paste. Each discrete heater extends between two of the conductive taps 14. The discrete heaters 12 can be made of a resistive paste (e.g., ESL 33000 series resistor paste produced by ESL Electro Science of King of Prussia, Pa.). The heater segments 12 and taps 14 provide a continuous electrical path from the first electrical tap 14-1 to the last electrical contact 14-m. Individual control of the heaters 12 facilitates the generation of a thermal gradient along a length of the segmented heater 11.

The thermal gradient can be statically maintained to attain a particular temperature profile, or dynamically controlled to vary or move the thermal gradient as desired by individually controlling the voltage or current supplied through the electrically conductive taps 14. For example, consider that initially all heater segments 12 are turned off. Then consider that the heater segments 12 are turned on, one at a time in sequence, with the previously turned on heater segment being turned off; for instance, the first heater 12-1 segment turns on, while the others are off; then the first heater segment 12-1 turns off while the second heater segment 12-2 turns on, and likewise so on, down the length of the heater 11 to the last heater segment 12-n. Hence, by dynamically turning individual heater segments 12 on and off at precise moments, the warm region of the thermal gradient marches along the full length of the segmented heater 11. In addition, the march of the warm region along the segmented heater 11 can be synchronized or coordinated with the flow of fluid through a fluidic channel within the microfluidic device 10. This is but one example how individual control of heater segments 12 can manipulate the shape and placement of a thermal gradient.

FIG. 1B shows an embodiment of thermal system 2, including a microfluidic device 10 having a continuous (i.e., non-segmented) thick film heater 15 with multiple electrically conductive taps 14. To show that the heater 15 is continuous the taps 14 appear to terminate at the edge of the heater 15; in actuality, they extend behind (underneath) the heater 15, where they make electrical contact with the heater 15. In a similar fashion as the thermal system 1 of FIG. 1, individual control of the taps 14 can produce a static or dynamically varying thermal gradient near a fluidic channel (not shown) within the microfluidic device 10.

FIG. 1C shows an embodiment of thermal system 3, including a microfluidic device 10 with a continuous thick film heater 15 bounded on two sides by spatially separated grooves or channels 16 cut into the surface of the substrate of the microfluidic device 10. The channels 16 operate to provide a thermal break that restricts the transfer of heat, and thus the thermal gradient, to the thermal region between the channels 16. In this embodiment of thermal system 3, the channels 16 converge; one end of the thermal region between the channels 16 is narrower than the other, opposite end of the thermal region. The narrowing of the thermal region between the channels 16 produces a thermal gradient from cooler temperatures (darker) at the wider end to warmer temperatures (lighter) at the narrower end. Although not shown, this embodiment of thermal system 3 includes two or more electrically conductive taps in electrical communication with the heater 15 to send a current through or apply a voltage across the heater 15.

FIG. 1D shows an embodiment of thermal system 4, including a microfluidic device 10 with a trapezoidal-shaped thick film heater 17. Not shown are electrically conductive taps; in one embodiment, there is one tap at each end of the heater 17 for causing a current to flow through the heater, producing heat by resistive heating; in another embodiment the taps partition the heater 17 into multiple heater segments. Alternatively, a current can be induced to flow through a heater made of ferromagnetic material (e.g., iron, nickel, cobalt, etc.).

Because the current density is greater at the narrow end of the trapezoid than at the wide end, the current flow through the heater 17 produces a thermal gradient from cooler (dark) temperatures at the wide end to warmer (light) temperatures at the narrow end. Other thick film heater shapes can be formed to produce a desired thermal gradient.

FIG. 1E shows an embodiment of thermal system 5, including a microfluidic device 10 and a rectangular continuous thick film heater 15 in thermal contact with the substrate of the microfluidic device 10. The rectangular continuous heater 15 is disposed at one side of the microfluidic device 10. Conduction of the heat produced by the heater 15 produces a natural thermal gradient, transitioning from warmer (lighter) temperatures at and near the heater 15 to cooler (dark) temperatures as the distance from the heater 15 increases. The microfluidic device 10 includes a chromatography column 18 formed therein, on the same or a different layer of the microfluidic device 10 from the heater 15. The column 18 and rectangular heater 15 are converging; one end of the column 18 is closer to the rectangular heater 15 than the other end of the column 18. Accordingly, the column 18 traverses the natural thermal gradient produced by the heater 15; the end of the column 18 closer to the rectangular heater 15 experiencing warmer temperatures than the end of the column 18 more distant from the heater 15. Consequently, a mobile phase traveling through the column 18 is exposed to this thermal gradient.

FIG. 1F shows an embodiment of a multi-zone thermal system 6, including a microfluidic device 10 and a rectangular continuous thick film heater 15 in thermal contact with the substrate of the microfluidic device 10. The rectangular continuous heater 15 is disposed at one side of the microfluidic device 10. The microfluidic device 10 includes a serpentine chromatography column 21 formed therein, on the same or a different layer of the microfluidic device 10 from the heater 15. One end of the serpentine chromatography column 20 is near the heater 15; the opposite end of the column 21 approaches the opposite end of the microfluidic device 10.

A thermal break 22 is formed in the substrate of the microfluidic device 10. In this example, the thermal break 22 is disposed within the eleventh bend of the serpentine chromatography column 21. The placement of the thermal break 22 operates to partition the thermal system 6 into two thermal zones 24-1 and 24-2. It is to be understood that the particular location of the thermal break 22 is only one example, used to illustrate a technique for producing multiple thermal zones. In addition, one or more thermal breaks of the same, similar, or different shapes and sizes may be deployed in conjunction with one or more thick film heaters to produce a thermal system with more than two thermal zones. Not shown are electrically conductive taps; in one embodiment, there is one tap at each end of the heater 15 for causing a current to flow through the heater, producing heat by resistive heating; in another embodiment the taps partition the heater 15 into multiple heater segments.

A thermal gradient is produced in thermal system 6 of FIG. 1F when the heater 15 is activated. Conduction of the heat produced by the heater 15 produces a natural thermal gradient in the thermal zone 24-1, transitioning from warmer temperatures at and near the heater 15 to cooler temperatures as the distance from the heater 15 increases. The thermal break 22 interrupts this thermal gradient and produces a substantially thermally uniform zone 24-2 on the side of the thermal break 22 opposite the heater 15. The chromatography column 21 traverses both the natural thermal gradient in the first zone 24-1 and the thermal uniformity in the second zone 24-2.

A secondary heater 23, shown in phantom, can be employed in the second thermal zone 24-2, disposed adjacent and parallel to the thermal break 22. Any of the aforementioned embodiments of rectangular thick film heaters (i.e., segmented, continuous) can be used to implement this secondary heater 23. Other placement locations for the rectangular thick-film heater 23 can be at the other end of the microfluidic device 10 opposite the thermal break 22, lengthwise (perpendicular to the thermal break 22) along the top or bottom of the microfluidic device 10, lengthwise (perpendicular or angled with respect to the thermal break 22) in a layer above or below the serpentine portion of the column 21, or any combination of such aforementioned locations, depending upon the particular desired thermal gradient, if any, within the second thermal zone 24-2.

FIG. 1G shows another embodiment of a multi-zone thermal system 7 including a microfluidic device 10 and a thick film heater 25 in thermal contact with the substrate of the microfluidic device 10. The heater 25 has the shape of a ring and is disposed at one end of the microfluidic device 10. Electrical contacts 27 provide connections for causing a current to flow through the heater 25. The microfluidic device 10 includes a chromatography column 26 formed therein, on the same or a different layer of the microfluidic device 10 from the heater 25. One section of the column 26 has a spiral shape; the spiral shape of the column 26 transitions into a serpentine shape.

A thermal break 22 is formed in the substrate of the microfluidic device 10 where the spiral shape transitions to the serpentine shape. The thermal break 22 operates to partition the thermal system 7 into two thermal zones 28-1 and 28-2. It is to be understood that one or more thermal breaks of the same, similar, or different shapes and sizes may be deployed in conjunction with one or more thick film heaters to produce a thermal system with more than two thermal zones. The spacing, or pitch, of the column 26 may or may not be constant in either or both of the zones 28-1, 28-2. For example, the pitch (or spacing between neighboring curves of the spiral) of the column 26 may vary as the column 26 traverses the spiral zone 28-1. Varying the pitch of the column 26 in the spiral zone 28-1 and or the spacing in the serpentine zone 28-2 can serve to linearize the spatial gradient in the column 26 if the thermal gradient is non-linear. Not shown are electrically conductive taps; in one embodiment, there is one tap at each end of the heater 25 for causing a current to flow through the heater, producing heat by resistive heating; in another embodiment the taps partition the ring-shaped heater 25 into multiple heater segments.

A thermal gradient is produced by the thermal system 7 of FIG. 1G when the heater 15 is activated. Conduction of the heat produced by the heater 25 produces a radial thermal gradient in the thermal zone 28-1, transitioning from warmer temperatures at and near the heater 25 to cooler temperatures as the distance from the heater 25 increases. The thermal break 22 interrupts this thermal gradient and produces a thermally uniform zone 28-2 on the side of the thermal break 22 opposite the heater 25. The chromatography column 26 traverses both the radial thermal gradient in the first zone 28-1 and the thermal uniformity in the second zone 28-2.

The multi-zone thermal system 7 of FIG. 1G is just one illustrative example. Other examples include, but are not limited to, a serpentine column in the first thermal zone 28-1 transitioning to a spiral in the second thermal zone 28-2; and a spiral column in the first thermal zone 28-1 transitioning to a second spiral in the second thermal zone 28-1.

Further, a secondary heater can be employed in the second thermal zone 28-2 to enhance thermal uniformity or produce a thermal gradient, if desired, within the second thermal zone. For example, a rectangular thick-film heater may be used for when the column 26 is serpentine within the second thermal zone 28-2, or a donut-shaped thick-film heater, similar to the heater 25, may be used for when the column 26 has a spiral shape within the second thermal zone 28-2.

In the instance of a serpentine-shaped column in the second thermal zone 28-2, a rectangular thick-film heater 29, shown in phantom, may be disposed adjacent and parallel to the thermal break 22 within the second thermal zone 28-2. Any of the aforementioned embodiments of rectangular thick film heaters (i.e., segmented, continuous) can be used to implement this secondary heater 29. Other placement locations for the rectangular thick-film heater 29 can be at the other end of the serpentine column 26 opposite the thermal break 22, lengthwise (perpendicular to the thermal break 22) along the top or bottom of the microfluidic device 10, lengthwise (perpendicular or angled with respect to the thermal break 22) in a layer above or below the serpentine portion of the column 26, or any combination of such aforementioned locations, depending upon the particular desired thermal gradient within the second thermal zone 28-2.

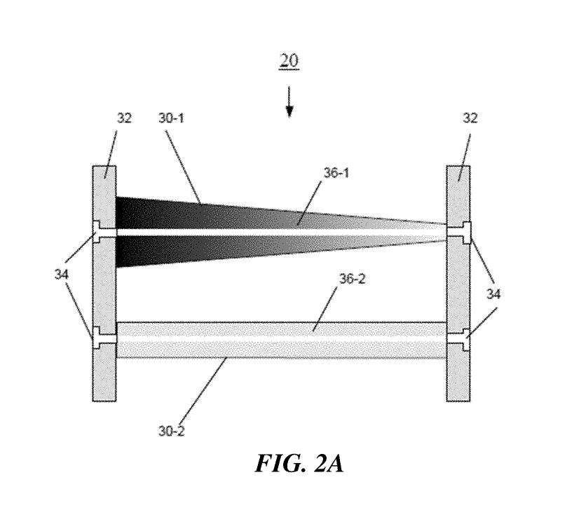

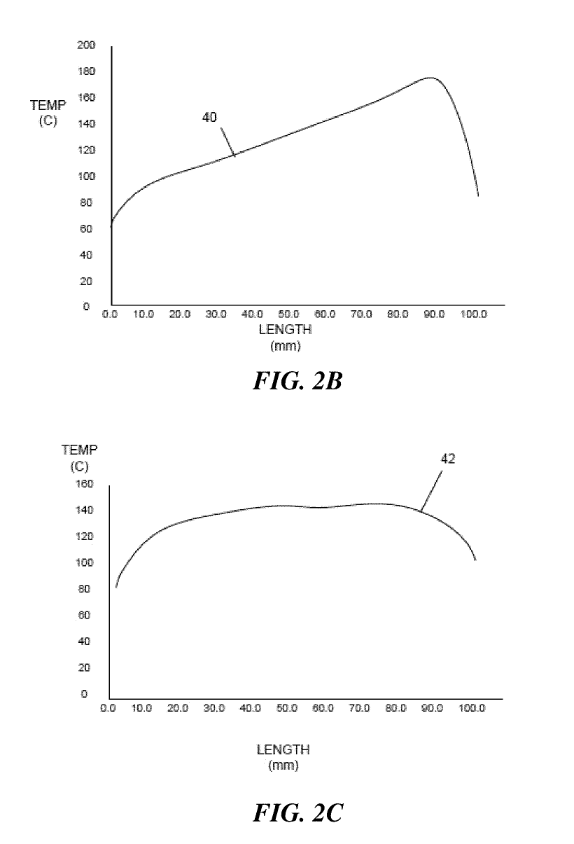

FIG. 2A shows an embodiment of a heater stack 20 comprised of two heaters, a trapezoidal heater 30-1 and a rectangular heater 30-2. The heaters 30-1, 30-2 are connected in parallel to electrical conduits 32 by electrically conductive taps 34, one tap 34 on each end of each heater. Two layers of resistor paste produce the heater stack 20; one layer for the trapezoidal-shaped heater 30-1 is screened on top of the other layer that provides the rectangular heater 30-2. The trapezoidal heater 30-1, when operating, produces a thermal gradient 36-1 that becomes increasing warmer (lighter) as the width of the heater. The rectangular heater 30-2, when operating, produces a generally uniform thermal gradient 36-2. The heater stack 20 can be formed on or within a substrate of a microfluidic device, where the combined effect of the heaters 30-1, 30-2 is in thermal communication with a fluidic channel. The combined effect can also operate to smooth out temperature spikes and droops.

Although shown connected in parallel for joint activation (i.e., either both are on or both are off), the heaters 30-1, 30-2 can alternatively be connected to be independently operable. Multiple independently operable heaters facilitate dynamic control of the thermal gradient within a fluidic channel. One heater 30-1 can serve as a primary heater, and another heater 30-2 as a supplemental heater. Consider, for example, that two stacked heaters 30-1, 30-2 are configured to produce thermal gradients in opposite directions; that is, the primary heater produces a warm-to-cool gradient in a reverse direction than the thermal gradient produced by the supplemental heater. Further consider that the primary heater is activated, while the supplemental heater is off. To neutralize quickly the thermal gradient produced by the primary heater, the primary heater can be turned off and the supplemental heater turned on. After neutralization, the thermal gradient can then be made to reverse.

FIG. 2B shows a thermal profile 40 for the trapezoidal-shaped heater 30-1 and FIG. 2C shows a thermal profile 42 for the rectangular heater 30-2. In each temperature profile 40, 42, the x-axis corresponds to a position along the length of the heater (position 0 mm corresponding to the left end of the given heater—as shown in FIG. 2A); the y-axis is the temperature produced by the given heater. Each thermal profile 40, 42 corresponds to the thermal gradient that can be produced by the heaters 30-1, 30-2, respectively.

The temperature profile 40 indicates that the thermal gradient 36-1 produced by the trapezoidal heater 30-1 ranges from about 60° C. at the wide end of the heater to a peak temperature of about 180° C. near its narrow end. The drop off in temperature at the narrow end of the heater 30-1 may be attributable to the cooling effect of the conductive tap 34.

The temperature profile 42 indicates that the thermal gradient 36-2 produced by the rectangular heater 30-2 ranges from about 60° C. at the left end of the heater to a peak temperature of about 145° C. near its right end. For a majority of the length of the heater 30-2, the temperature produced is relatively constant; the temperatures are lowest where the heater 30-2 makes contact with the electrically conductive taps 34. It is to be understood that such terms like above, below, upper, lower, left, right, top, bottom, front, and rear are relative terms used for purposes of simplifying the description of features as shown in the figures, and are not used to impose any limitation on the structure or use of a thermal system or heater configuration.

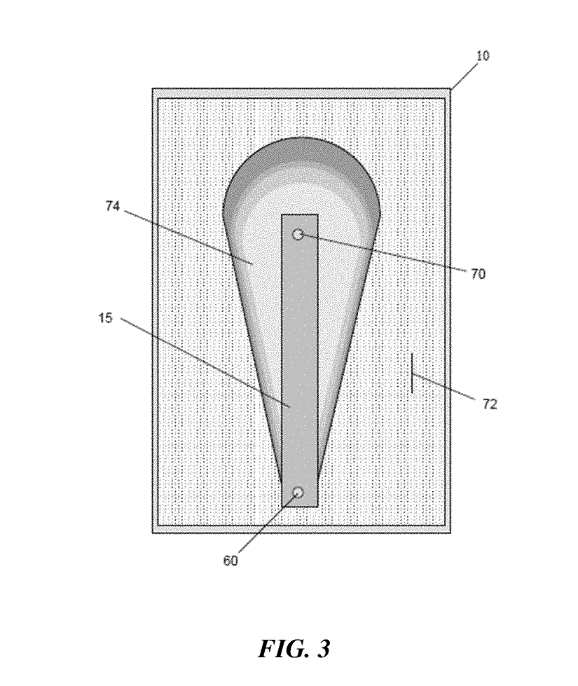

FIG. 3 shows an embodiment of a technique for shaping a thermal gradient using a thick film heater and a shaped cooling mechanism. In this embodiment, the microfluidic device 10 has a fluidic channel formed in an intermediate layer of the device 10. The fluidic channel is not visible in FIG. 3; a uniform watt thick film heater 15 is disposed over the fluidic channel (on a different layer of the substrate from the channel). An inlet 60 and outlet 70 to the fluidic channel are shown at opposite ends of the heater 15. The inlet 60 and outlet 70 are through-holes or vias that extend through the layer of the thick film heater 15 to provide ports into and out of the fluidic channel, respectively.

Heat transfers laterally from the sides and from the ends of the heater 15; a thermal gradient 70 forms with the warmer (lighter shading) temperatures being adjacent the heater 15. A cooling element 72 (e.g., a passive cooling element such as a heat sink or an active cooling element such as a Peltier device) is in thermally conductive contact with a surface of the microfluidic device 10 surrounding the heater 15. The cooling element 72 can maintain the surrounding region at ambient temperature. A region of the surface of the microfluidic device 10 remains uncovered by the cooling element 72. The shape of the uncovered region shapes the thermal gradient 74. In this embodiment, the cooling element 72 surrounds a tapered (teardrop) shaped uncovered region. The surrounded region is cooler where it is near or abuts the cooling element 72, and warmer with greater lateral distances from the cooling element 72. The resulting teardrop-shaped thermal gradient 74 (warm to cool being represented by lighter shading transitioning to darker shading) is warm near the sides and top of the heater 15 and increasingly cooler as it progresses nearer to the cooling element 72.

Although implementations described above relate primarily to microfluidic devices, spatial thermal gradients can be implemented in other types of liquid chromatography systems. For example, spatial thermal gradients can be implemented in analytical scale chromatography columns (e.g., approximately 2.1-4.6 mm i.d.) and preparative scale chromatography columns (e.g., approximately 7 to 100 mm i.d.). U.S. Patent Publication Nos. 2016/0266076 A1 and 2016/0266077 A1, titled “System and Method for Reducing Chromatographic Band Broadening in Separation Devices” and “Static Spatial Thermal Gradients for Chromatography at the Analytical Scale,” respectively, the entireties of which are incorporated herein by reference, describe different configurations of thermal systems used to create and control spatial thermal gradients for analytical scale and preparative scale chromatography columns. The spatial thermal gradient may be generated to address a radial thermal gradient generated in the liquid chromatography column. The spatial thermal gradient may be formed external to the column and extend longitudinally along the column. To produce a spatial thermal gradient along a column, a variety of techniques may be employed, including, for example, heating near and around the column with one or more resistive heaters, passing a cooling gas over the column, and extending the column through a multi-zone heater assembly.

Control of the formation of the spatial thermal gradient can be implemented using, for example, a control module such as a processor or specific circuitry in communication with a thermal system, in an open loop or closed loop fashion. A closed-loop system for temperature control of the spatial gradient along the length of the column can employ temperature measurement elements placed upstream and downstream of the column to provide feedback.

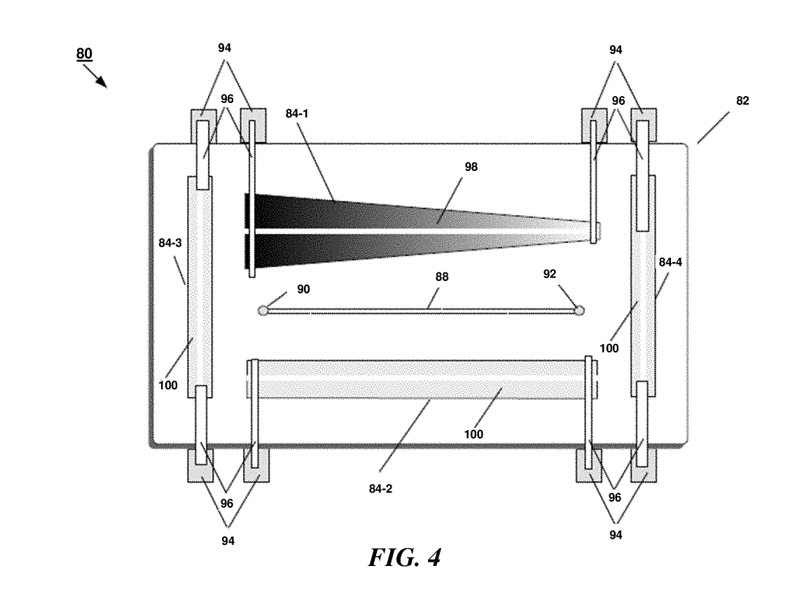

FIG. 4 shows an embodiment of a thermal system 80 including a multilayer microfluidic device 82, a plurality of thick-film heaters 84-1, 84-2, 84-3, and 84-4 (generally, 84), made of thick-film paste, integrated with the microfluidic device 82, and a separation column (i.e., fluidic channel or chromatography column) 88. Each thick film heater 84 is formed on an interior or exterior substrate layer of the microfluidic device 82. The heaters 84 may be on the same or on different layers. Each heater 84 is connected to electrical conduits 94 by an electrically conductive tap 96 on each end of that heater. Each of the four heaters is independently controllable (i.e., can be turned on and off independently of the other heaters).

In this embodiment, the heaters 84 surround the separation column 88 on four sides. The heaters 84-1 and 84-2 are connected in parallel to each other on opposite sides of the separation column, which extends longitudinally between the heaters 84-1, 84-2. The separation column 88 appears in phantom to illustrate that the column 88 may be fully enclosed within the layers of the microfluidic device 82. An ingress aperture 90 and an egress aperture 92 connect to the head end and exit end, respectively, of the column 88. The heaters 84-3 and 84-4 are connected in parallel to each other on ends of the separation column 88, extending generally perpendicular to the column 88 and the heaters 84-1 and 84-2. The heater 84-3 is at the head end of the separation column 88; the heater 84-4 is at the tail end.

The heater 84-1 is trapezoidal in shape, whereas the other heaters 84-2, 84-3, and 84-4 are rectangular. The wide end of the trapezoidal heater 84-1 is near the head end of the separation column 88 and the narrow end is at the tail end of the separation column 88. Other shapes for the heater 84-1 include triangular, geometries without straight edges, and any such shape that can produce a thermal gradient similar to that produced by the trapezoidal shape.

The manufacture of the microfluidic substrate with the one or more thick film heaters 84, 86 may use Low-Temperature Co-fired Ceramic (LTCC) or High-Temperature Co-fired ceramic (HTCC) tapes. Examples of LTCC tapes include the 951 Green Tape™ ceramic tape produced by DuPont Microcircuit Materials of Research Triangle Park, N.C., and LTCC ceramic tapes produced by ESL Electro Science of King of Prussia, Pa. LTCC technology enables low-temperature (about 850° C.) co-firing of the thick film heater and substrate layers of the multilayer microfluidic device. These microfluidic devices can be made, for example, of ceramic, silicon, silica, polymers, polyimide, stainless steel, or titanium. Examples of multilayer microfluidic devices are described in U.S. Pat. No. 8,931,356, titled “Chromatography Apparatus and Methods Using Multiple Microfluidic Substrates”, the entirety of which is incorporated by reference herein. Examples of techniques for producing microfluidic devices with an integrated thermal gradient-producing thermal system are described in U.S. Patent Publication No. 2016/0167048 A1, titled “Apparatus and Methods for Creating a Static and Traversing Thermal Gradient on a Microfluidic Device”, the entirety of which is incorporated by reference herein.

The trapezoidal heater 84-1, when operating, produces a thermal gradient 98 that becomes increasing warmer (lighter) as the width of the heater decreases. The rectangular heaters 84-2, 84-3, and 84-4, when operating, produce a generally uniform thermal gradient 100. The combined effect of the four heaters 84 produces a spatial thermal gradient outside and along a length of the separation column 88. This spatial thermal gradient provides an exterior thermal environment of the separation column 88, and is configured to counteract a change in a property of this mobile phase as the mobile phases through the separation column 88, as described in more detail below. In this example, the combined effect is to produce an exterior thermal environment that is warmer at the egress end 92 of the column 88 than at the ingress end 90 to counteract radial gradients in liquid chromatography. In an alternative configuration, wherein the narrow end of the trapezoidal heater 84 is at the ingress end 90 of separation column 88, the spatial thermal gradient can be cooler at the egress end 92 than at the ingress end 90. The combined effect can also operate to smooth out temperature spikes and droops.

Multiple independently operable heaters facilitate dynamic control of the thermal gradient within a fluidic channel. One heater 84-1 can serve as a primary heater, and another heater 84-2 as a supplemental heater; the role of the supplemental heater is to shape the spatial thermal gradient, for example, warmer temperatures near the inlet with an exponential temperature decay towards the outlet, warmer at the inlet with a linear decay toward the outlet. This enables the generation of linear and exponential temperature curves along the length of the channel 88.

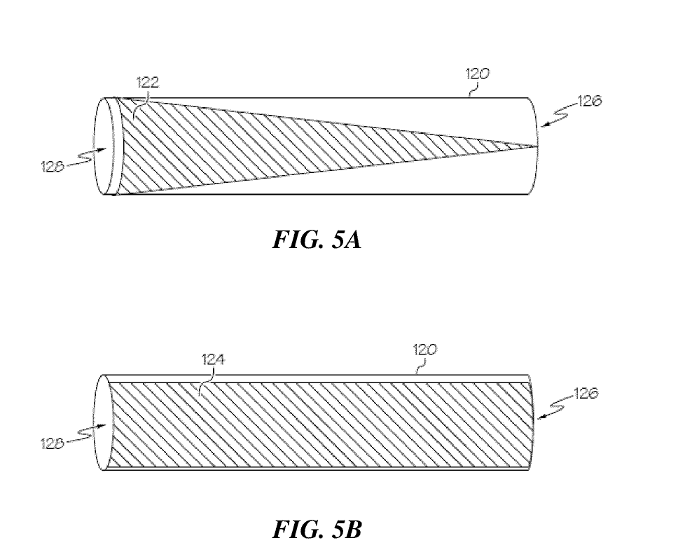

FIG. 5A shows one side of an embodiment of an analytical scale packed-bed chromatography column 120 (e.g., 1 mm-5 mm ID). A triangular-shaped resistive heating element 122 is disposed on an external surface of the chromatography column 120. The resistive heating element 122 is a metallic surface that tapers to a point at one end of the column (which can be the column inlet or outlet, depending on the type of spatial gradient desired). The region of the column 120 left uncovered by the heating element 122 is thermally non-conductive. Like the trapezoidal-shaped heater 84 of FIG. 4, the resistive heating element 122 is warmer at the narrow tip than at the wider end when operating. The isosceles triangle shape of the heating element 122 ensures better temperature distribution in the radial direction on the 3-D cylindrical column 120 than would the right triangle shape of the heater 84 of FIG. 4.

FIG. 5B shows an opposite side of the analytical scale chromatography column 120 of FIG. 5A. On this side is a rectangular-shaped resistive heating element 124. This heating element 124 is thermally insulated from the other heating element 122 of FIG. 5A. Like the rectangular-shaped heater 86 of FIG. 1, this resistive heating element 124 produces a generally uniform thermal gradient and can be used as a supplemental heater to set a base temperature.

The combined effect of the heaters 122, 124 of FIG. 5A and FIG. 5B, respectively, produces a spatial thermal gradient on the exterior of the separation column 120. In this example, the combined effect is to produce an exterior surface that is warmer at the one end 126 of the column 120 than at the opposite end 128. Example implementations of the heaters 122, 124 can include, but are not limited to, heating elements that are screen-printed, laminated, or integrated to the column surface, thick film pastes, mica heaters, and flexible heating circuits.

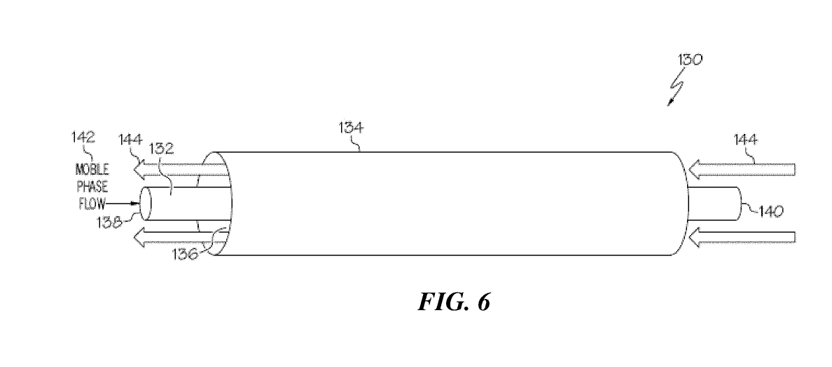

FIG. 6 shows an embodiment of a thermal system 130 for producing an external spatial thermal gradient for an analytical (or preparative) scale chromatography column 132. A heated column sleeve 134 surrounds the chromatography column 132. The column sleeve 134 may be heated by thermal elements disposed remotely to and in thermal communication with thermally conductive material on the column sleeve 134. Alternatively, such thermal elements may be disposed in direct physical contact with a surface of the sleeve. Examples of heaters for heating the column sleeve 134 include, but are not limited to, a flex heating circuit, pastes disposed on a thermally conductive surface, mica heaters, and a remotely heated block of thermally conductive material (for example, a thermoelectric device can be disposed remotely with respect to the sleeve, having a thermal connection (e.g., a heat pipe) to the block of thermally conductive material).

An air gap 136 surrounds the chromatography column 132 and separates the sleeve 134 from the external surface of the chromatography column 132. A mobile phase 142 flows into an inlet end 138 of the chromatography column 132, towards an outlet end 140. A cooling gas 144 flows through the air gap 136 between the sleeve 134 and the column 132 in a direction opposite the direction of mobile phase flow, starting at the column outlet 140 and flowing towards the column inlet 138. Heat from the heated sleeve 134 warms the gas 144 as the gas flows toward the inlet end 138 of the column 132. The external spatial thermal gradient produced by the combination of the heated sleeve 134 and cooling gas 144 is warmer at the column inlet 138 than at the column outlet 140. The external spatial thermal gradient may be designed to maintain a substantially constant density of the mobile phase as the mobile phase cools while flowing through the length of the column 132. This embodiment facilitates simple and inexpensive removal of the column 132 from the heating apparatus because the heater may not be physically coupled to the column 132. Further, the embodiment of FIG. 6 can be implemented separately or together with the embodiment of FIGS. 5A and 5B.

Although described in connection with heaters, cooling elements disposed on or remotely coupled to the sleeve 134 can operate to cool the sleeve 134. In addition, a warming, ambient temperature, or cooled gas can flow through the air gap.

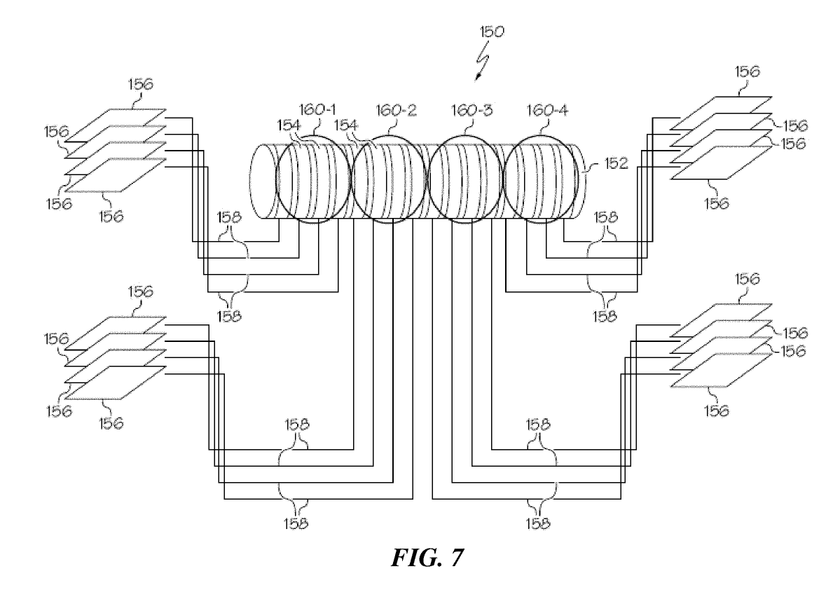

FIG. 7 shows of an embodiment of a thermal system 150 for producing a spatial thermal gradient around the exterior of an analytical (or preparative) scale chromatography column 152. Wrapped circumferentially around the chromatography column 152 is a plurality of spatially separated discrete temperature heating elements 154. The heating elements 154 can be metallic rings or other structures that encircle the column 152. The elements can be made of metals of high thermal conductivity, for example, silver and copper, or non-metallic compounds, for example, diamond, or highly thermally conductive ceramic, for example, alumina. The heating elements 154 may be disposed on an exterior surface of the chromatography column 152, on the interior of a column heating compartment, or on a sleeve (such as the heated sleeve 134 of FIG. 6) surrounding the column 152. Each discrete heating element 154 may be individually operable. Each heating element 154 is controlled by a remote heater 156 thermally coupled to that heating element 154 by a heat-transfer device (“heat pipe”) 158. Alternatively, the remote heaters 156 can be cooling devices, with each heating element 154 instead being a cooling element. The remote heaters (or coolers) 156 can be implemented with a stack of Peltier elements. Peltier elements enable generation of temperature gradients over a wide range of temperatures, from extreme cold to high heat.

In an alternative embodiment, the heating elements 154 can be themselves be heaters (e.g., screen-printed thick film pastes), each almost fully encircling the column 120. Further, the remote heaters 156 and corresponding heating elements 154 can be grouped to produce a spatial thermal gradient with multiple thermal zones, for example, zones 160-1, 160-2, 160-3, and 160-4 (generally, 160), each zone 160 consisting of four heating (or cooling) elements 154. Using fine discrete metallic devices enables high resolution temperature profiles at precise locations along the column length.

The number of heaters (or coolers) 156 and associated elements 154 determines the precision and resolution of the desired temperature gradient. Together, the heating (or cooling) elements 154 may be cooperatively controlled to produce a cooling or warming thermal gradient along the exterior surface (or wall) of the column 152 from the inlet to the outlet. In addition, the spatial thermal gradient can be statically maintained to attain a particular temperature profile. Alternatively, the spatial thermal gradient can be dynamically controlled to vary or move the spatial thermal gradient, as desired, by individually controlling the energy flowing to and from the elements 154 through the heat pipes 158. In a further embodiment the dynamically controlled spatial thermal gradient is automatically responsive to thermodynamic modeling software. Alternatively, the dynamic control of the spatial thermal gradient is based on a database (e.g., lookup table or discrete database) containing thermodynamic properties. The dynamic changes can be made throughout the duration of the separation by a temperature controller (not shown) in communication with the heaters (or coolers) 156. Such dynamic changes enable the thermal system 150 to continuously adapt during a pressure/temperature/composition gradient.

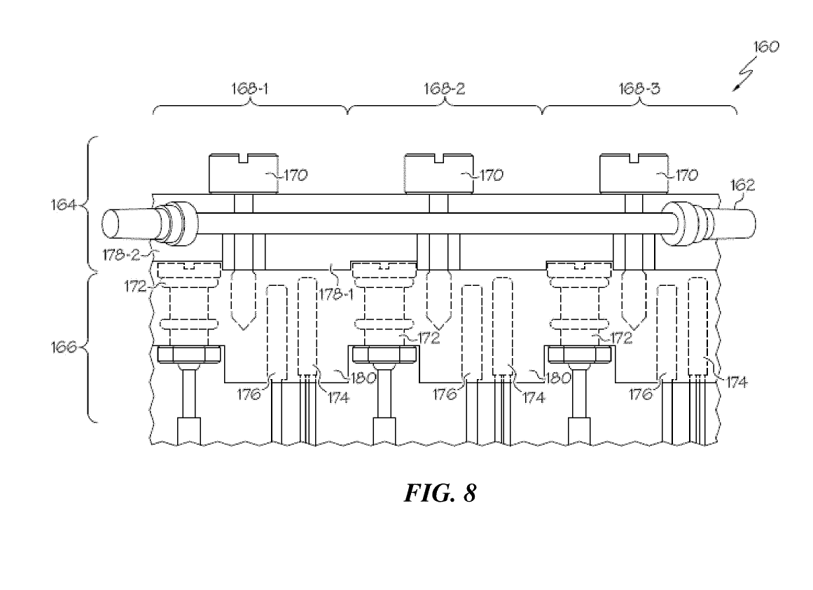

FIG. 8 shows a transparent side view of an embodiment of a multi-zone thermal system 160 that can be used to produce an external spatial thermal gradient around an analytical (or preparative) scale chromatography column 162. The multi-zone thermal system 160 includes a thermally conductive column block 164 coupled to, and in thermal communication with, a thermally conductive thermal block 166. The chromatography column 162 passes through the column block 164. (Although described with respect to an analytical scale chromatography column, the multi-zone thermal system can be used to produce a spatial thermal gradient for a fluidic channel embedded in the column block 164). A thermal gasket (not shown) may be disposed at select regions between the thermal block 166 and the column block 164.

This embodiment of the multi-zone thermal system 160 has three thermal zones 168-1, 168-2, and 168-3 (generally, thermal zone 168), although other embodiments can have as few as two or more than three thermal zones. Each thermal zone 168 may include a retention mechanism 170 to hold the portion of the column block 164 in that zone in thermal communication with the portion of the thermal block 166 also of that zone. The retention mechanism 170 may include a screw that enters an appropriately sized opening in a top side of the column block 164, passes entirely through the column block 164, and fastens into an appropriately sized opening in a top side of the thermal block 166.

The thermal block portion of each thermal zone 168 includes a thermistor assembly 172, a heater 174, and a safety switch 176. In each thermal zone 168, the heater 174 and safety switch 176 within the thermal block 166 are disposed near and directly opposite a first region 178-1 of the column block 164, and the thermistor assembly 172 is disposed directly opposite a second region 178-2 of the column block 164. The thermistor assembly 172 is in thermal communication with the second region 178-2 of the column block 164 and may be substantially thermally isolated from the thermal block 166. This thermal isolation ensures that the temperature of the column block 164 of each thermal zone, as measured by the thermistor assembly 172, is substantially uninfluenced by the temperature of the thermal block portion of that thermal zone. In addition, each thermal zone 168 is insulated from its neighboring thermal zone or zones by a thermal insulation block 180.

Circuitry actively controls the temperature of the thermal block 166 in each zone 168 by controlling operation of the heater 174 in that zone. Each zone 168 may have a different temperature setting, thereby producing a spatial thermal gradient along the length of the column block 164. The safety switch 176 in each zone 168 measures the temperature of the thermal block 166 near the heater 174 of that zone 168, and may operate to disable the heater 174 should its measured temperature exceed a threshold. The thermally conductive thermal block 166 conducts the heat generated by the heater 174 to the column block 164, predominantly through the first region 178-1. The thermistor assembly 172 measures the temperature of the second region 178-2 of the thermal zone 168. This measured temperature closely or exactly corresponds to the temperature of the column 162 in that thermal zone 168, and may be used as feedback in a closed-loop system.

In this example, the chromatography column 162 passes through three thermal zones 168-1, 168-2, and 168-3 (generally, 168) of a thermal system. Each thermal zone 168 can have a different temperature setting, with the temperature settings decreasing from left to right along the length of the column 162. For example, the temperature setting in the leftmost thermal zone 168-1 can be 40° C., 30° C. in thermal zone 168-2, and 20° C. in the rightmost thermal zone 168-3. These particular temperatures settings produce an external spatial thermal gradient with a downward sloping profile. The spatial thermal gradient produced by the temperature settings causes a gradual decline in the column temperature from left to right along the length of the column 162.

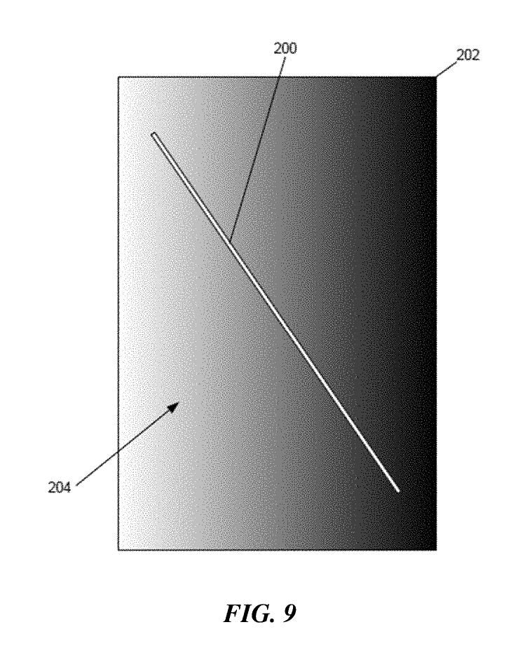

FIG. 9 shows another embodiment in which a static thermal gradient is established along a length of a column 200 by placing the column 200 in thermal communication with a surface 202 on which a thermal gradient 204 is already established. In FIG. 9, warmer regions are lighter and cooler regions are darker, with the temperature gradient passing from warmer to cooler temperatures moving from left to right across the surface 202. Changing the angle of the column 200 relative to the thermal gradient 204 establishes different temperature gradient slopes along the length of the column 200. For example, positioning the column 200 parallel (horizontal in FIG. 9) to the thermal gradient direction establishes a steep slope, whereas positioning the column normal (vertical in FIG. 9) to the thermal gradient direction produces an isothermal condition along the length of the column 200.

In the various embodiments of a method of performing a chromatographic separation described below, the composition gradient of a mobile phase in a chromatographic column and a traversing spatial temperature gradient along the length of the chromatographic column are changed simultaneously to achieve an improvement in chromatographic performance by enhancing peak compression. The characteristics (spatial steepness and velocity) of the composition and spatial temperature gradients can be independently defined by the chromatographer. For example, a smooth and fast composition gradient can be combined with a steep and slowly moving spatial temperature gradient. Alternatively, a slow composition gradient can be combined with a rapidly traversing spatial temperature gradient. The characteristics for a particular application are chosen to improve the peak capacity per unit time for the chromatographic system relative to a traditional composition gradient separation with an isothermal column environment. In some implementations, the peak capacity may improve by approximately 30% or more relative to a separation performed using only a composition gradient.

In the following embodiments, the gradient composition has a conventional linear change in time or temporal steepness. Assuming that the composition gradient is not distorted during propagation through the chromatographic column, the composition gradient propagates at a constant linear velocity U_{A} as follows:

$${u}_{A} = \frac{{u}_{0}}{1 + {k}_{A}^{′}}$$

where u₀ is the chromatographic linear velocity and k′_{A} is the constant retention factor of the strong solvent on the stationary phase for any mobile phase and applied temperature during the composition gradient. Consequently, the variation of the volume fraction φ(z,t) of the strong solvent in the mobile phase as a function of elapsed composition gradient time t and column axial position z is given by:

$$ϕ ( z , t ) = {ϕ}_{0} + β ( t - \frac{z}{{u}_{A}} )$$

where t=0 when the composition gradient first reaches the column inlet (z=0), φ₀ is the initial volume fraction of the strong solvent in the mobile phase mixture and β is the temporal steepness of the composition gradient.

The temperature spatial gradient is a dynamic gradient that moves along the length (i.e., parallel to the column axis) of the chromatographic column in time, and is characterized by a temporal steepness τ and a linear velocity u_{T}. Thus the temperature along the chromatographic column as a function of time is given by:

$$T ( z , t ) = {T}_{0} + τ ( t - \frac{z}{{u}_{T}} )$$

where T₀ is the initial temperature at the column inlet at the time t=0 when the spatial thermal gradient first begins to move along the column axis.

The velocities u_{A} and u_{T} of the composition gradient and spatial temperature gradient, respectively, can be independently controlled and coordinated to enable an improvement in chromatographic peak capacity over a separation performed using only a composition gradient. Preferably the velocity u_{A} and the temporal steepness β of the composition gradient are arbitrarily chosen by the experimenter. Then, the temporal steepness τ of the temperature gradient is also arbitrary and should be at least equal to the ratio of the temperature amplitude to the elution time of the last retained compound. Finally, the velocity u_{T} is imposed so that the spatial temperature gradient is completed throughout the time when the composition gradient traverses the length of the column:

$${u}_{T} = \frac{L}{\frac{L}{{u}_{A}} + \frac{{ϕ}_{2} - {ϕ}_{1}}{β} - \frac{{T}_{M ax} - {T}_{0}}{τ}}$$

where L is the column length, φ₁ and φ₂ are the volume fractions of strong solvent in the mobile phase at the beginning and end, respectively, of the composition gradient, T₀ is the initial temperature when the temperature gradient starts and T_{Max} is the maximum temperature set at the end of the temperature gradient.

More specifically, the movement of the spatial temperature gradient is preferably maintained throughout the time when any part of the composition gradient is in the column. This includes a “start time” from when the composition gradient first occurs, or arrives, at the column inlet to an “end time” when the end of the composition gradient first reaches the column outlet. Alternatively, the movement of the spatial temperature gradient may be terminated once a last analyte of interest is eluted from the column outlet.

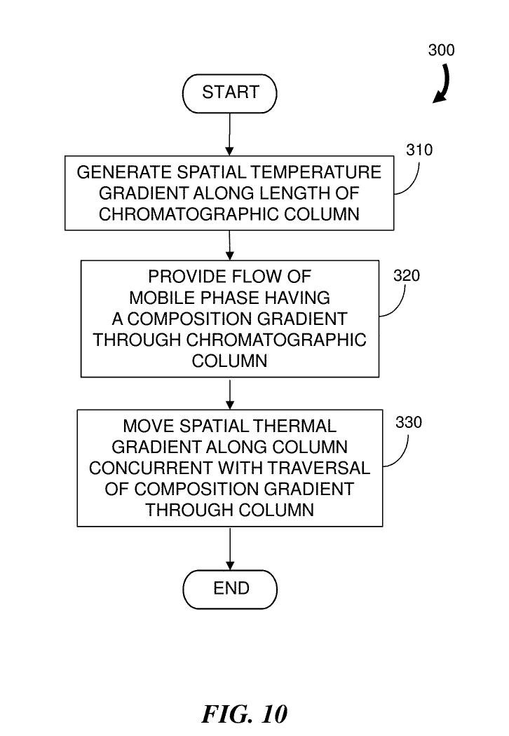

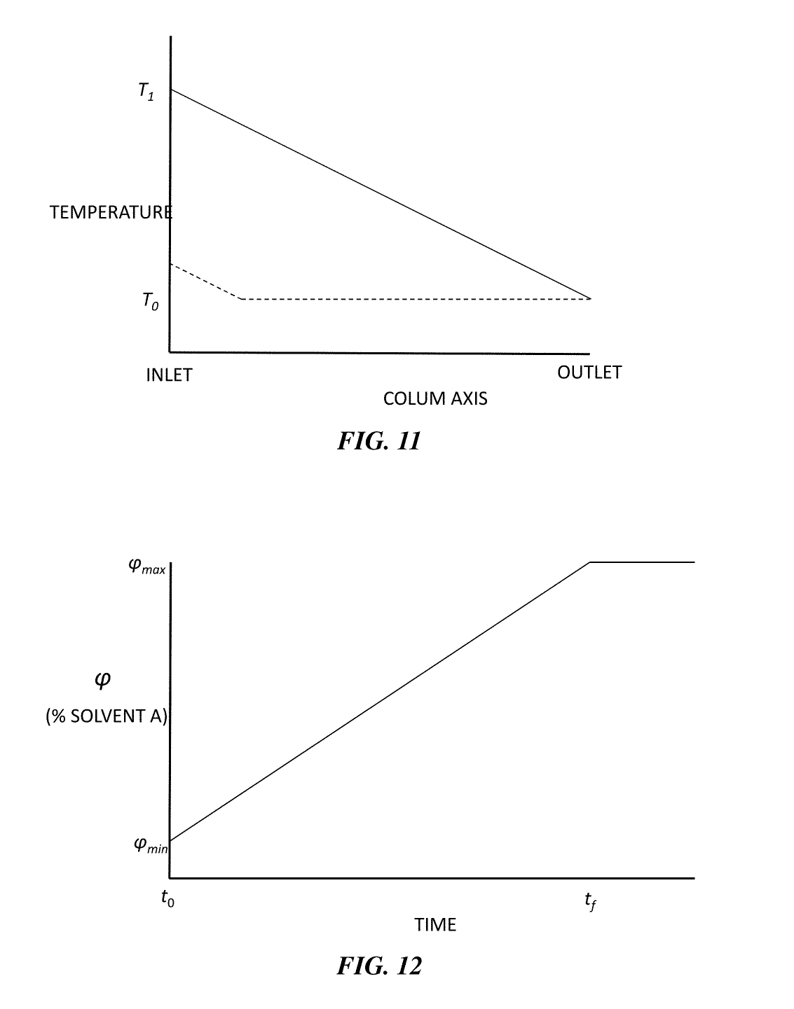

FIG. 10 shows one embodiment of a method 300 of performing a chromatographic separation. According to the method 300, a spatial temperature gradient is generated (310) along a length of the chromatographic column. The temperature decreases from a value T₁ at the column inlet to a lower temperature T₂ at the column outlet. The spatial temperature gradient may have a linear profile as shown in FIG. 11 where the dashed line indicates the temperature gradient shortly after initiation and the solid line indicates the temperature gradient at a later time when the temperature gradient has moved sufficiently so that it extends across the full length of the column. In some embodiments, the temperature difference between the inlet and outlet (T₁−T₀) is set at as high a value that the chromatographic system can accommodate throughout the separation. A mobile phase having a gradient composition is provided (320) to the chromatographic column. The composition gradient may be programmed into a user interface for the liquid chromatography system as is known in the art. For example, the gradient composition may be programmed as the relative contribution of a strong solvent to the total solvent flow over time. The gradient composition is linear if the rate of relative increase of the strong solvent remains constant throughout the duration of the composition gradient, as shown in FIG. 12 for a fixed location along the column axis where the relative contribution φ of the strong solvent increases from a minimum of φₘᵢₙ at time t₀ to a maximum of φₘₐₓ at a time t_{f}. In some implementations, the relative contribution increases from 0% to 100% over the duration of the composition gradient. In other implementations, the gradient composition is not linear.

The gradient mobile phase is generally preceded by a mobile phase that has a constant composition (e.g., an isocratic portion of the mobile phase). The sample may be injected into the constant composition portion. When the composition gradient arrives at the column inlet so that the composition of the mobile phase at the column inlet first begins to change (at time t₀), the spatial temperature gradient is made to begin to move (330) along the chromatographic column such that a portion of column nearest the column inlet first experiences the gradient while the remainder of the column nearer to the column outlet does not yet experience the temperature gradient (see dashed line in FIG. 11). Subsequently, the spatial temperature gradient will extend across the full length of the column (see solid line in FIG. 11).

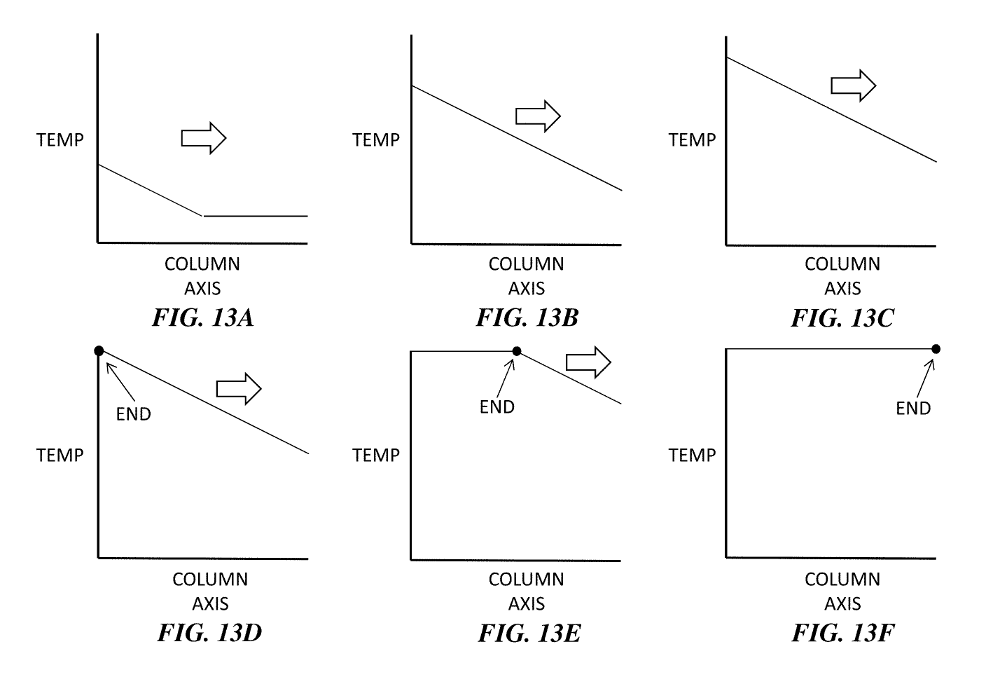

FIGS. 13A to 13F show a time sequence of an example of how a linear spatial temperature gradient is made to move along the column axis. At a time t₀, when the composition gradient first arrives at the inlet of the chromatographic column, a spatial temperature gradient is made to move along the column axis as indicated by the arrow. FIG. 13A shows the spatial temperature gradient after having propagated approximately half way along the length of the column. Once the spatial temperature gradient extends across the full column length, the temperature at each location along the column axis is increased at a constant rate that is proportional to the velocity u_{T} of the spatial temperature gradient moving along the column axis. Thus the spatial temperature gradient appears to move to the right with increasing time as shown in FIG. 13B, 13C and then 13D.

The spatial thermal gradient along the column axis is preferably terminated at the location of the end of the composition gradient (i.e., when the maximum contribution of the strong solvent first occurs) along the column axis. This location corresponds to the labeled “END” point in FIGS. 13D to 13F which effectively moves along the column axis at the velocity u_{A} of the composition gradient. In this manner, the end of the spatial thermal gradient and the end of the composition gradient arrive at the column outlet at the same time to substantially maximize the improvement in peak capacity; however, for some ballistic composition gradients, the velocity u_{T} of the spatial thermal gradient may be limited by system component properties from matching the velocity u_{A} of the composition gradient.

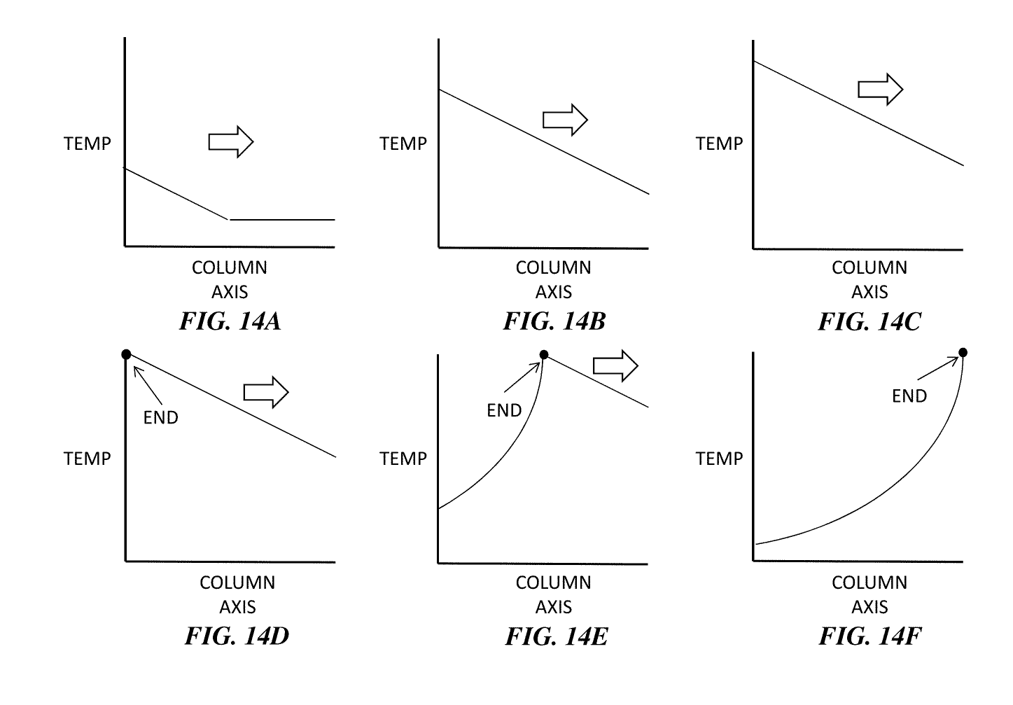

The termination of the spatial thermal gradient may be implemented as a plateau in the temperature profile at a maximum temperature as shown in FIG. 13D to FIG. 13F. The maximum temperature may be near or at a predefined temperature limit. For example, the maximum temperature may be determined according to the limit of thermal stability of the column, a limitation on the thermal output of the heaters, or the thermal capacity of other system components near or at the chromatographic column. Alternatively, the termination of the spatial thermal gradient may be achieved, for example, by reducing or terminating the thermal output of one or more heaters such that temperatures along the column axis upstream from the end of the composition gradient passively drop to lower temperatures. For example, FIGS. 14A to 14F show a time sequence of how a linear spatial temperature gradient moves along the column axis; however, the temperature along the column axis behind the end of the composition gradient is allowed to decrease by the reduction of applied thermal energy, as shown specifically in FIGS. 14D to 14F. Alternatively, after termination of the spatial thermal gradient, active cooling may be applied to return the temperature along the column axis to an initial state.

The timing of the initiations and terminations of the movement of the spatial thermal gradient and the composition gradient respect to the column inlet and column outlet may be programmed through a user interface and/or control module used to control the thermal system and one or more solvent pumps. The programmed initiation and termination times for the composition gradient should account for the delay in the propagation of the composition gradient in the fluidic pathway from the one or more solvent pumps to the chromatographic column. Similarly, the programmed initiation and termination times for movement of the spatial thermal gradient should account for thermal lag in the material after issuance of thermal commands. In this manner a more accurate synchronization of the moving spatial gradient to the composition gradient may be achieved with a resulting improvement in peak compression.

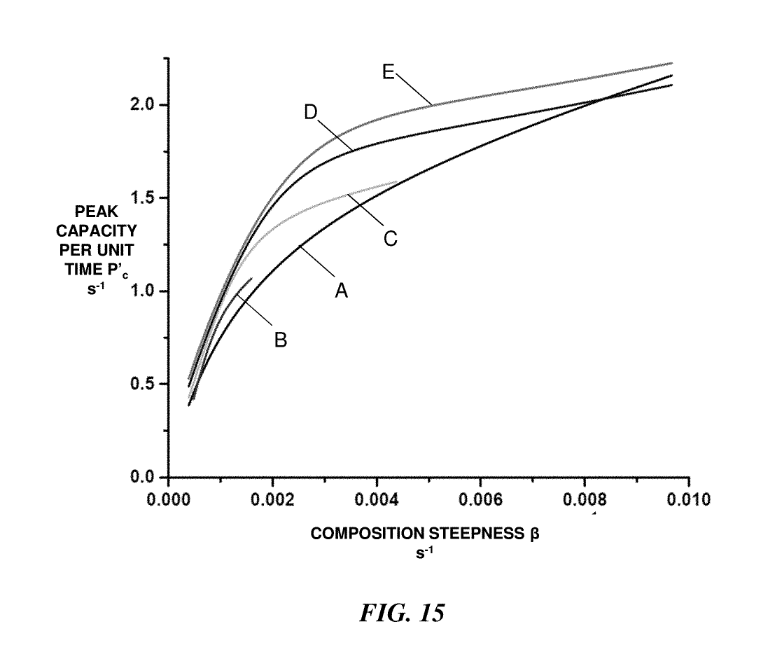

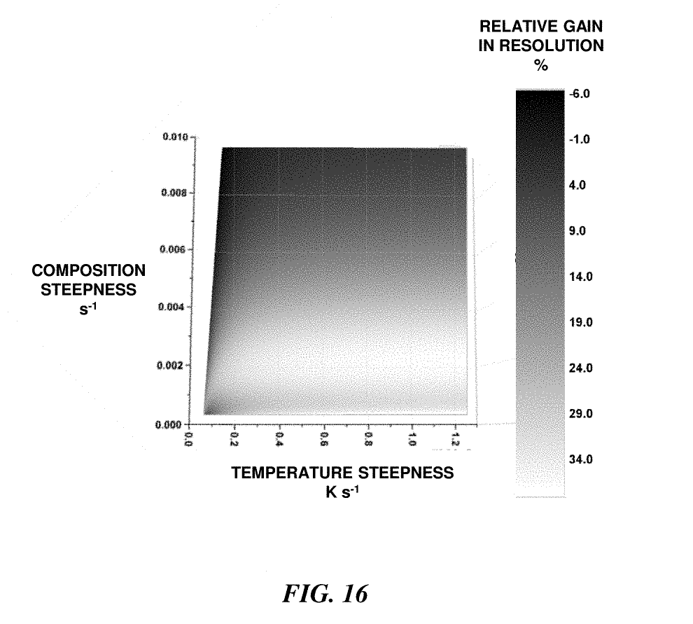

FIG. 15 is a graphical representation of the peak capacity of a liquid chromatography system per unit time as a function of composition gradient steepness and temperature steepness. Curve A shows a relationship for a separation performed under a conventional, isothermal column environment. Curves B, C, D and E correspond to temperature steepness values of 0.05 Ks⁻¹, 0.10 Ks⁻¹, 0.20 Ks⁻¹ and 0.60 Ks⁻¹, respectively. It can be seen that the difference in peak capacity per unit time is most obvious when the composition gradient steepness is between 0.002 s⁻¹ and 0.006 s⁻¹, and the rate of increase of the spatial thermal gradient is above 0.2 Ks⁻¹. At any one composition gradient steepness, there is an increase in peak capacity per unit time with increased temperature steepness therefore it is preferable to operate with a maximum temperature difference that can be established and maintained between the column inlet and column outlet by the chromatographic system. In relative terms, the greatest percentage improvement over a conventional, isothermal composition gradient is observed with a composition gradient steepness of 0.002 s⁻¹ and a temperature steepness greater than 0.80 Ks⁻¹ as can be seen in the graphical representation shown in FIG. 16.

For most analytes, the direction of the spatial temperature gradient described above (i.e., greatest at the column inlet to least at the column outlet) is generally desired; however, in certain applications in which compounds are retained according to an inverse temperature relationship, it may be preferable to have the direction of the spatial temperature gradient reversed. More specifically, applications in which compounds are increasingly retained in the stationary phase as the temperature is increased may benefit from a spatial thermal gradient that is formed so that the greatest temperature is at the column outlet and the lowest temperature is at the column inlet. The spatial thermal gradient is moved along the column axis so that the temperature at each location along the column axis is reduced with increasing time. Thus a spatial thermal gradient having a slope that is opposite in sign to the embodiments previously described can be moved in a direction from the column inlet toward the column outlet.

In most embodiments of the method described above, the contribution of the strong solvent to the total solvent composition increases linearly in time; however, in other embodiments of the method the contribution of the strong solvent may be customized for a particular application and may be non-linear in time. In addition, the spatial thermal gradient is primarily described above as a linear and monotonic gradient; however, non-linear spatial thermal gradient profiles defined along the column axis may be used, including gradients that have a non-monotonic profile along the column axis.

The velocity of the spatial thermal gradient is described above as being constant; however, it should be recognized that the velocity may be changed over time to achieve particular benefits for certain liquid chromatography applications. In such instances, the relative improvement over a conventional, isothermal composition gradient is different from that described above with respect to FIG. 16. For example, there may be instances where the mobile phase flow rate is change and/or the composition gradient is non-linear. Under such circumstances, the temperature steepness changes accordingly to maintain the optimal or commanded ratio between the temperature steepness and the composition steepness. In an example in which the mobile phase flow rate is reduced, the composition gradient will take more time to traverse the length of the column and therefore the velocity of the thermal gradient is reduced accordingly.

While the invention has been shown and described with reference to specific preferred embodiments, it should be understood by those skilled in the art that various changes in form and detail may be made therein without departing from the spirit and scope of the invention as defined by the following claims.

1. A method of performing a chromatographic separation, the method comprising:
generating a spatial temperature gradient along a length of a chromatographic column between an inlet of the chromatographic column and an outlet of the chromatographic column;
providing a flow of a mobile phase having a composition gradient to the chromatographic column, the composition gradient phase having a start time and an end time; and
moving the spatial temperature gradient along the length of the chromatographic column from the inlet to the outlet during the composition gradient.

2. The method of claim 1 wherein the moving of the spatial temperature gradient is initiated at the start time of the composition gradient.

3. The method of claim 2 wherein the moving of the spatial gradient is terminated at the end time of the composition gradient.

4. The method of claim 1 wherein a temperature at the inlet is greater than a temperature at the outlet.

5. The method of claim 1 wherein a temperature at the inlet is less than a temperature at the outlet.

6. The method of claim 1 wherein the spatial temperature gradient comprises a monotonic variation in temperature between the inlet and the outlet of the chromatographic column.

7. The method of claim 1 wherein the spatial temperature gradient at the start time comprises a substantially linear spatial temperature change between the inlet and the outlet of the chromatographic column.

8. The method of claim 1 wherein, for at least a portion of time between the start time and the end time, the spatial gradient includes a first gradient region in which the temperature varies for a first portion of the length of the chromatographic column and a second gradient region in which the temperature is constant for a second portion of the length of the chromatographic column.

9. The method of claim 1 wherein the start time is a time when a first change occurs in a composition of the mobile phase at the inlet of the chromatographic column.

10. A method of performing a chromatographic separation, the method comprising:
generating a spatial temperature gradient along a length of a chromatographic column between an inlet of the chromatographic column and an outlet of the chromatographic column, the spatial temperature gradient having an inlet temperature and an outlet temperature;
injecting a sample into a flow of an isocratic mobile phase to the chromatographic column;
providing a flow of a mobile phase having a composition gradient to the chromatographic column after the sample is received at the chromatographic column, the composition gradient having a start time and an end time; and
moving the spatial temperature gradient along the length of the chromatographic column from the inlet to the outlet during the composition gradient.

11. The method of claim 10 wherein the moving of the spatial temperature gradient is initiated at the start time of the composition gradient.

12. The method of claim 11 wherein the moving of the spatial gradient is terminated at the end time of the composition gradient.

13. The method of claim 10 wherein a temperature at the inlet is greater than a temperature at the outlet.

14. The method of claim 10 wherein a temperature at the inlet is less than a temperature at the outlet.

15. The method of claim 10 wherein the spatial temperature gradient comprises a monotonic variation in temperature between the inlet and the outlet of the chromatographic column.

16. The method of claim 10 wherein the spatial temperature gradient at the start time comprises a linear spatial temperature change between the inlet and the outlet of the chromatographic column.

17. The method of claim 10 wherein, for at least a portion of time between the start time and the end time, the spatial gradient includes a first gradient region in which the temperature varies for a first portion of the length of the chromatographic column and a second gradient region in which the temperature is constant for a second portion of the length of the chromatographic column.

18. A chromatographic system, comprising:
a solvent delivery system configured to provide a mobile phase having a composition gradient;
a chromatographic column in fluidic communication with the solvent delivery system to receive the mobile phase;
a thermal system in thermal communication with the chromatographic column and configured to generate and dynamically control a spatial temperature gradient along a length of the chromatographic column; and
a control module in communication with the solvent delivery system and the thermal system, the control module configured to control the thermal system to move the spatial temperature gradient along the length of the chromatographic column from the inlet to the outlet during the composition gradient.

19. The chromatographic system of claim 18 wherein the control module is configured to command the thermal system to control a velocity at which the spatial gradient moves along the length of the chromatographic column.

20. The chromatographic system of claim 18 further comprising a sample manager in communication with the control module and configured to inject a sample into the mobile phase.

21. The chromatographic system of claim 18 wherein the thermal system is configured to maintain a constant temperature difference between an inlet of the chromatographic column and an outlet of the chromatographic column for at least a portion of a chromatographic separation.
